(19) United States
(12) Patent Application Publication
(10) Pub. No.: US 2005/0189438 A1
(43) Pub. Date: Sep. 1, 2005

(54) Pull-out water sprayer

(75) Inventor: Orlando Bosio, Casaloldo (IT)

Correspondence Address: MODIANO & ASSOCIATI, Via Meravigli, 16, MILANO, 20123, IT

(73) Assignee: AMFAG S.p.A.

(21) Appl. No.: 11/063,772

(22) Filed: Feb. 24, 2005

(30) Foreign Application Priority Data
Mar. 1, 2004 (IT) MN2004A000005

(51) Int. Cl. A62C 31/00; B05B 1/30

(52) U.S. Cl. 239/443; 239/587.1

(57) ABSTRACT

A pull-out water sprayer comprising a water conveyance body provided, at its inlet end, with a coupling to a flexible hose and comprising a switching device that is adapted to provide access of the water selectively to a first duct, which is connected to a central discharge port, and to a second duct, which is connected to peripheral ports, the water conveyance body being divided into two interconnected sections, each of which comprises a portion of the first and second ducts.

The present invention relates to a pull-out water sprayer.

### BACKGROUND OF THE INVENTION

Water sprayers are known which are connected to a flexible hose so that they can be pulled out of faucets in order to reach different positions, as occurs for example in kitchen sinks, and in a particular embodiment such sprayers convey water with the possibility to provide the output in the form of a central jet or of a peripheral jet following a simple action on an appropriately provided switching device.

Known sprayers suffer some drawbacks, such as for example a certain difficulty in providing the ducts that convey water from the switching device toward the outlet ports, or a defective mating that is often noticed between the sprayer and the faucet.

### SUMMARY OF THE INVENTION

Therefore the aim of the present invention is to provide a sprayer in which such drawbacks are eliminated.

The proposed aim is achieved by a pull-out water sprayer, comprising a water conveyance body provided, at its inlet end, with means for coupling to a flexible hose comprised within a faucet and associated, at the output end, with a disk that comprises a central port and peripheral ports for the passage of water, said body comprising a switching device that is adapted to provide the access of the water selectively to a first duct, which is connected to said central port, and to a second duct, which is connected to said peripheral ports, characterized in that said water conveyance body is divided into two interconnected sections, each of which comprises a portion of said first and second ducts.

### BRIEF DESCRIPTION OF THE DRAWINGS

Further characteristics and advantages will become better apparent from the description of a preferred but not exclusive embodiment of the pull-out water sprayer according to the invention, illustrated by way of non-limiting example in the accompanying drawings, wherein:

FIGS. 1 and 2 are two, side and front views of the sprayer;

FIG. 3 is a view of the sprayer fitted on a faucet, with said faucet partially removed for illustration purposes;

FIG. 4 is a partial exploded view of the sprayer shown in the faucet of FIG. 3;

FIG. 5 is a sectional view, taken along the line V-V of FIG. 2;

FIG. 6 is the same sectional view, taken in a different operational configuration;

FIG. 7 is a prospective view of the lever of the switching device;

FIGS. 8 and 9 are views of the water conveyance body, respectively in the disassembled condition and in the assembled condition.

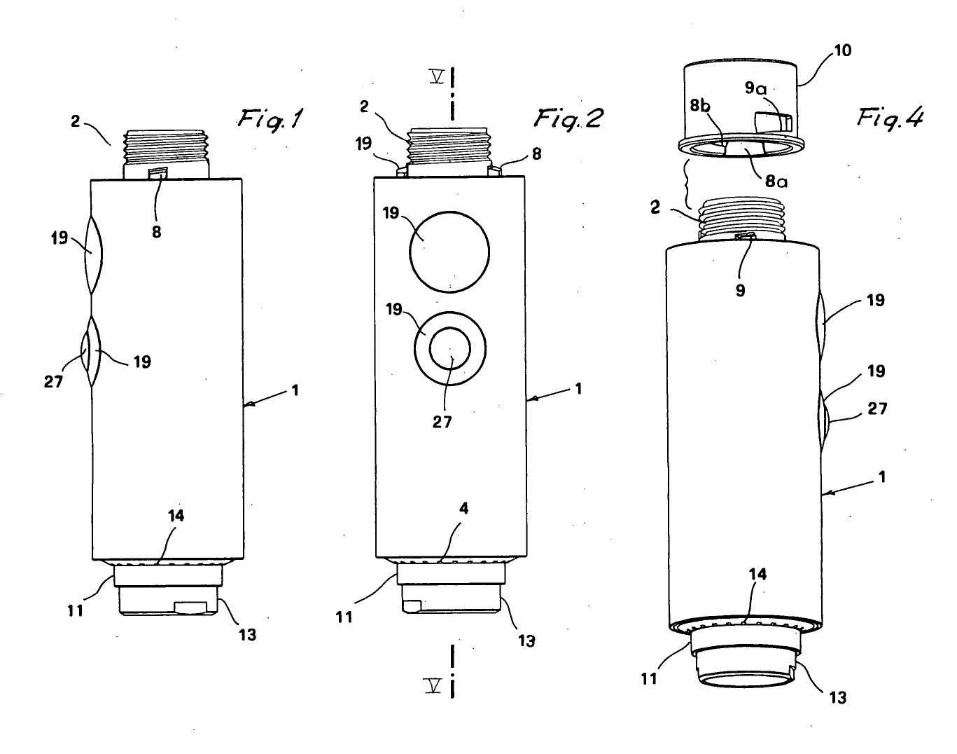

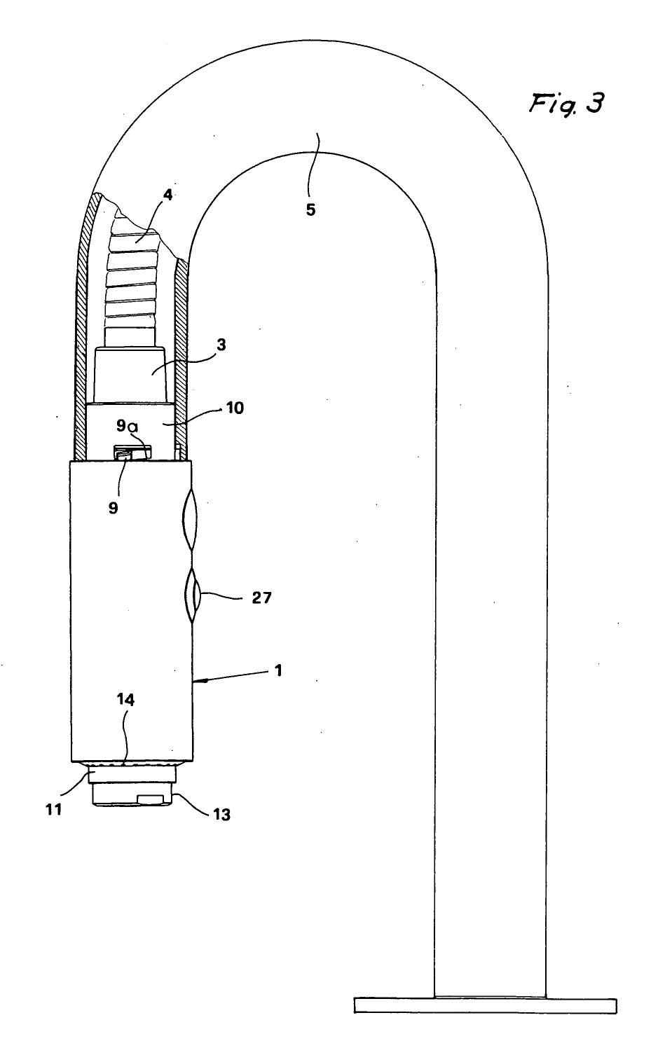

### DESCRIPTION OF THE PREFERRED EMBODIMENTS

With reference to the figures, the reference numeral 1 generally designates the sprayer provided with means for coupling, in particular a thread 2 for coupling to the end 3 of a flexible hose 4 comprised within a faucet 5.

More specifically, the thread 2 protrudes from a water conveyance body, generally designated by the reference numeral 6 and described hereinafter, which is comprised within an external enclosure 7.

The reference numerals 8 and 9 designate two wings that protrude monolithically from the body 6 and are inclined so as to provide substantially portions of screw threads that are designed to enter, following a translational motion in the direction of the axis of the sprayer, respective notches provided in a bush 10, which is locked at the end of the faucet 5, and to make contact, following a rotary motion imparted by the user to the sprayer, with abutments, such as inclined planes that are adjacent to said notches and are also formed within the bush 10: in this way, the wing 8 is designed to enter a notch 8a and make contact with an adjacent inclined plane 8b, while the wing 9, after entering a notch not shown in the figures, is designed to make contact with an inclined plane 9a.

It clearly appears that the sprayer assumes, during engagement with the faucet 5, a helical motion that leads it to a stable engagement position, with the assurance of making contact with the terminal rim of the faucet 5, thus protecting at the same time functional and aesthetic requirements.

Obviously, the inclined planes 8b and 9a can be replaced with different abutments, so long as they are capable of ensuring the condition of helical motion of the sprayer as described above.

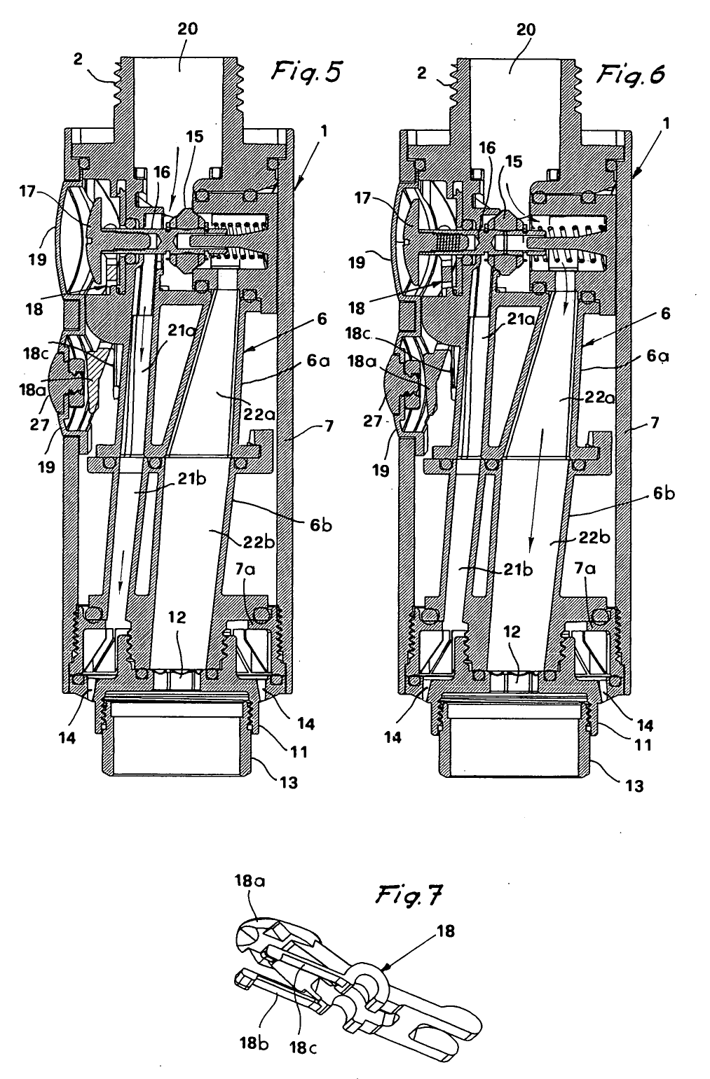

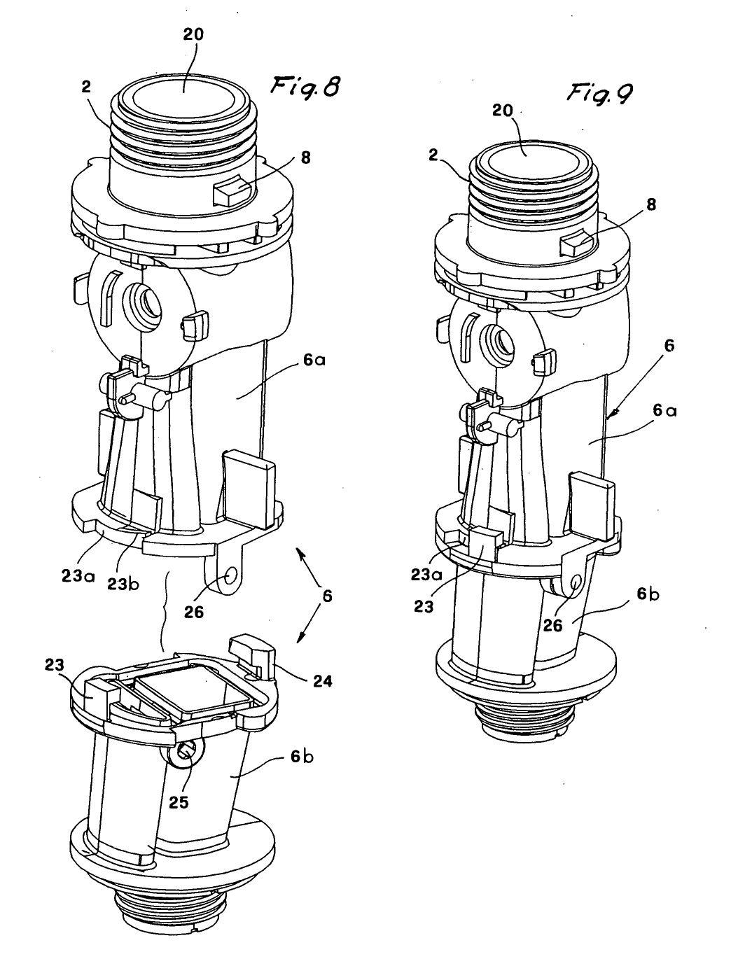

The water conveyance body 6 is now described with particular reference to FIGS. 5, 6, 8 and 9; said body is provided, as mentioned, at the inlet of the threaded portion 2, with a connection to the flexible hose 4 and is associated at its output with a disk 11, which comprises a central port 12, provided with a ring 13 for containing an aerator, not shown in the figures, and peripheral ports such as 14.

It is indeed the association with the disk 11 that achieves the locking of the body 6 with respect to the external enclosure 7, the protrusion 7a whereof remains indeed closed between the body 6 and the disk 11.

The body 6 accommodates a switching device, which comprises a flow control element 15 associated with a rod 16, which has, at one end, a button 17, and accommodates a lever 18, which is associated with the button 17 at a first end, is pivoted at the body at the center, and is shaped like a further button at a second end 18a; a hood 19, made of an elastic material such as rubber, covers the button 17 and the end 18a of the lever.

The switching device is per se known; it is enough to note that the situation of FIG. 5 provides the connection, illustrated by the arrows, of an inlet duct 20 to the second duct that conveys the water to ports such as 14, thus achieving the peripheral jet, while the situation of FIG. 6 provides the connection, also illustrated by the arrows, of the inlet duct 20 to the first duct that conveys the water to the port 12, thus providing the central jet.

The body 6 is divided into two sections, respectively designated by the reference numerals 6a and 6b, each of which contains a portion of said water conveyance ducts: accordingly, the section 6a contains a portion 21a and the section 6b contains a portion 21b of the second duct that conveys water to the peripheral ports, and the section 6a contains a portion 22a and the section 6b contains a portion 22b of the first duct that conveys water to the central port.

In this manner it is particularly easy to provide said ducts.

The two sections 6a and 6b are detachably connected to each other by way of connection means that comprise the L-shaped tabs 23 and 24, which protrude from the section 6b and are adapted to enter with a translational motion a notch provided in the section 6a, such as 23a for a tab 23, and to then make contact, as a consequence of a rotary motion, with an inclined-plane contact region that is adjacent to said notch, such as 23b again for the tab 23, obtaining therefrom a helical relative motion of the two sections that causes their engagement: cavities or seats such as 25 and 26, formed respectively in the section 6b and in the section 6a, are intended to be arranged so that they face each other in the position for engaging the two sections that is shown in FIG. 9, so as to allow accommodation of a pin that is adapted to ensure the stability of the coupling.

The L-shaped element and the corresponding contact region may of course assume any configuration, so long as it is capable of ensuring the above cited helical motion condition.

Going back now to the switching device, it is noted that the button 17 is associated with the end of the rod 16 by means of a thread, and that a stud 27 is provided that is inserted in the hood region 19 that lies above the end 18a of the lever, so as to provide an element that allows strong tactile identification.

Finally, on the lever 18 there are two tabs 18b and 18c, which have good elastic characteristics and which, by making contact with the wall of the duct portion 21a ensure stable placement of said lever in every functional condition.

The described invention is susceptible of numerous modifications and variations in addition to the ones already mentioned, all of which are within the scope of the appended claims: thus, for example, the notches for the passage of the wings 8 and 9 or of the tabs 23 and 24 may assume any shape.

The disclosures in Italian Patent Application No. MN2004A000005 from which this application claims priority are incorporated herein by reference.

1. A pull-out water sprayer, comprising: a water conveyance body; coupling means provided at an inlet end of said body for coupling thereof to a flexible hose comprised within a faucet; a disk arranged at an output end of the body and comprising a central port and peripheral ports for passage of water; a first duct, which is connected to said central port; a second duct, which is connected to said peripheral ports; and a switching device adapted to provide access of water selectively to said first or second ducts, and wherein said water conveyance body is divided into two interconnected sections, each of which comprising a portion of said first and second ducts.

2. The sprayer of claim 1, wherein said water conveyance body is divided into said two sections which are detachably interconnected.

3. The sprayer of claim 1, wherein said two sections of the water conveyance body are detachably interconnected by way of at least one L-shaped tab that protrudes from a first one of said sections adapted to enter, with translational motion, a notch provided in a second one of said sections, said L-shaped tab being further arrangeable, upon a rotary motion, in contact with a contact region that is adjacent to said notch, the L-shaped element and said contact region being shaped so as to produce a helical relative motion of the first and second sections such as to provide engagement thereof, said first and second sections being provided with at least two seats that face each other in an engagement position and accommodate a pin adapted to ensure connection stability in said engagement position.

4. In a faucet, a pull-out water sprayer, comprising: a water conveyance body; a flexible hose that is comprised within the faucet; coupling means provided at an inlet end of said body for coupling to said flexible hose; at least one inclined wing, shaped so as to provide a screw thread portion; a notch provided at an end of the faucet; an abutment that is adjacent to said notch, said inclined wing being adapted to enter, by translational motion, said notch and contact, upon further rotation motion said abutment, whereby to provide a helical motion of the sprayer that assumes a condition of detachable and stable engagement with the faucet.

5. The sprayer of claim 4, comprising two inclined wings arranged in mutually opposite positions.

6. The sprayer of claim 4, comprising a bush that is monolithically associated with an end of the faucet and comprises at least one notch with an adjacent abutment that is adapted for association with said at least one inclined wing provided on the sprayer.

7. The sprayer of claim 6, wherein said adjacent abutment is shaped as an inclined plane.

8. The sprayer of claim 4, comprising: a switching device for switching from a central jet to a peripheral jet and vice versa, said switching device comprising: a flow control element; a rod provided with a button at one end that is associated with said rod; a lever having a first end associated with said button, a center region with a fulcrum pivoted at said body, and a second end that is shaped like a further button, and wherein said lever comprises at least one tab with elastic characteristics that protrudes from the center region thereof proximate to the fulcrum towards the second end of said lever, to make contact with a fixed contact portion of the body.

9. The sprayer of claim 8, wherein said button of the switching device is screwed at said one end of the rod that is associated with the flow control element.

10. The sprayer of claim 8, comprising: a hood made of an elastic material for covering the button associated with the rod and the further button provided at the second end of the lever of the switching device; and a stud that protrudes from an external surface of the hood at a region that lies above one of the button and further button.
